(19) United States
(12) Patent Application Publication
(10) Pub. No.: US 2021/0394497 A1
(43) Pub. Date: Dec. 23, 2021

(54) MULTI-LAYER FILMS AND METHOD OF USING

(71) Applicant: Raven Industries, Inc., Sioux Falls, SD (US)

(72) Inventors: Steven G. Redford, Brandon, SD (US); Dylan Rogers, Sioux Falls, SD (US)

(21) Appl. No.: 17/349,017

(22) Filed: Jun. 16, 2021

Related U.S. Application Data
(60) Provisional application No. 63/040,322, filed on Jun. 17, 2020.

(51) Int. Cl. B32B 27/08; B32B 37/18

(52) U.S. Cl. CPC B32B 27/08; B32B 2255/205; B32B 2255/10; B32B 37/182

(57) ABSTRACT

Various embodiments of the present disclosure provide a multi-layer film. The multi-layer film includes a first polymeric layer; a second polymeric layer; and a printed polymeric layer comprising a visual image and disposed between the first polymeric layer and the second polymeric layer.

### CROSS REFERENCE TO RELATED APPLICATION

This application claims priority to U.S. Provisional Application No. 63/040,322 filed on Jun. 17, 2020, titled “MULTI-LAYER FILMS AND METHOD OF USING”, the contents of which are hereby incorporated by reference.

### BACKGROUND

Printed media can be exposed to a variety of harsh elements such as oxygen and ultraviolet radiation. Exposure to any of these can be harmful to the printed media and can make the media unreadable. Because printed media can be used for a variety of purposes it is important to be able to protect it when disposed in a location where it can be subject to damage.

### SUMMARY OF THE INVENTION

Various embodiments of the present disclosure provide a multi-layer film. The multi-layer film includes a first polymeric layer; a second polymeric layer; and a printed polymeric layer comprising a visual image and disposed between the first polymeric layer and the second polymeric layer.

Various further embodiments of the present disclosure provide a multi-layer film. The multi-layer film includes a first polymeric layer; a second polymeric layer; and a printed polymeric layer comprising a visual image and disposed between the first polymeric layer and the second polymeric layer. The first polymeric layer, the second polymeric layer or both include an additive or mixture of additives to inhibit the transmission of oxygen, inhibit the transmission of electromagnetic radiation, absorb electromagnetic radiation, an antioxidant, a stabilizer, an antifogging compound, or a combination thereof. The visual image comprises words, a picture, a pattern, numbers, or a combination thereof.

Various further embodiments of the present disclosure provide an assembly. The assembly includes a multi-layer film. The multi-layer film includes a first polymeric layer; a second polymeric layer; and a printed polymeric layer comprising a visual image and disposed between the first polymeric layer and the second polymeric layer. The assembly includes a substrate adhered to the multi-layer film. The visual image on the printed polymer layer is visible on a surface of the substrate through the first or second polymeric layer.

Various further embodiments provide a method of making a multi-layer film. The multi-layer film includes a first polymeric layer; a second polymeric layer; and a printed polymeric layer comprising a visual image and disposed between the first polymeric layer and the second polymeric layer. The method includes arranging the first polymeric layer, second polymeric layer, and printed polymeric layer to form a multi-layer film precursor. The method further includes laminating the multi-layer film precursor to form the multi-layer film.

Various further embodiments provide a method of using a multi-layer film. The multi-layer film includes a first polymeric layer; a second polymeric layer; and a printed polymeric layer comprising a visual image and disposed between the first polymeric layer and the second polymeric layer. The method include bonding the multi-layer film to a substrate and forming a void in the multi-layer film and at least partially through the substrate.

### BRIEF DESCRIPTION OF THE FIGURES

The drawings illustrate generally, by way of example, but not by way of limitation, various embodiments of the present invention.

FIG. 1 is a sectional view of a multi-layer film in accordance with various examples.

FIG. 2 is a sectional view of a multi-layer film in accordance with various examples.

FIG. 3 is a sectional view of a multi-layer film in accordance with various examples.

FIG. 4 is a sectional view of a multi-layer film in accordance with various examples.

FIG. 5 is a sectional view of a multi-layer film in accordance with various examples.

FIG. 6 is a sectional view of a multi-layer film in accordance with various examples.

FIG. 7 is a sectional view of a multi-layer film in accordance with various examples.

FIG. 8 is a sectional view of a multi-layer film in accordance with various examples.

FIG. 9 is a top view of a multi-layer film in accordance with various examples.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

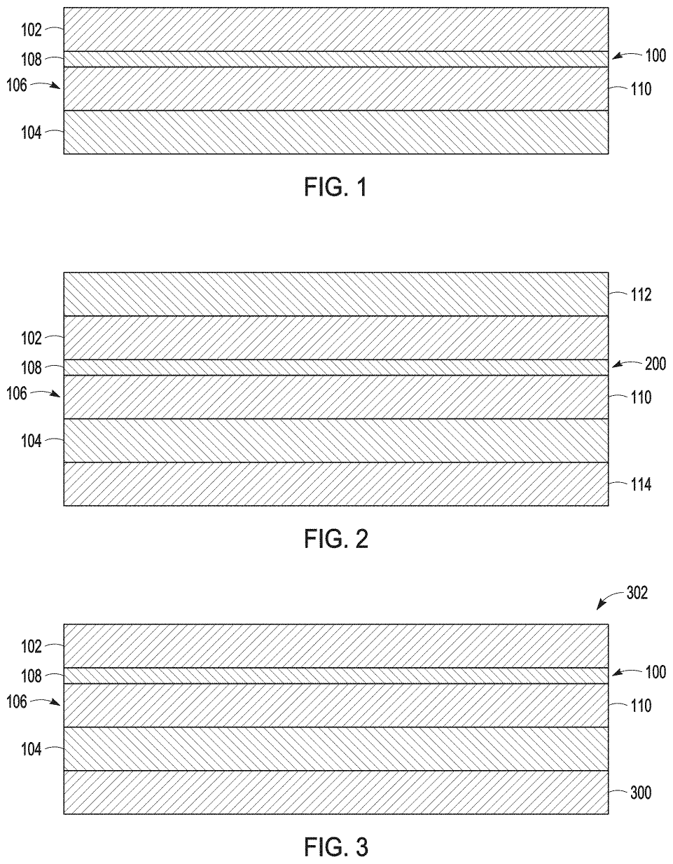

Various examples of the present disclosure relate to a multi-layer film and assembly incorporating the same. FIG. 1 is an example of multi-layer film assembly 100. Multi-layer film assembly 100 includes first polymeric layer 102, second polymeric layer 104, and printed polymeric layer 106.

Printed polymeric layer 106 is embedded between first polymeric layer 102 and second polymeric layer 104. Printed polymeric layer 106 includes visual image 108 disposed on polymeric material 110. As shown in FIG. 1, visual image 108 is disposed adjacent to first polymeric layer 102. However in other examples, visual image 108 can instead be disposed adjacent to second polymeric layer 104.

Printed polymeric layer 106 can include many different features. For example, printed polymeric layer can include a visual image 108 that includes a word, a picture, a pattern, numbers, or a combination thereof. Visual image 108 can be purely aesthetic (e.g., include no functional characteristics). For example, visual image 108 can display a pattern or image that is aesthetically pleasing. Alternately, visual image 108 may be functional it that it may convey a logo, address, phone number, a QR code, or the like. Visual image 108 could also be an advertisement. In some further examples, visual image 108 can effectively be a set of instructions. For example, visual image 108 can instruct a person how to get a location (e.g., a map). In still further examples, visual image 108 can convey a set of construction instructions. For example, the instructions can instruct a user where to form a void (e.g., drill a hole) through multi-layer film 100, staple, nail, or otherwise alter multi-layer film 100. This can help a user to avoid transferring dimensions from a blueprint to a surface and reduces the risk of errors caused by incorrect measurements. The appearance of visual image 108 can be altered or enhanced by placing visual image 108 on a metalized surface. Visual image 108 can be formed of an opaque ink, a transparent ink, a conductive ink, or a mixture thereof. The ink of visual image 108 can include any desirable color or combination of colors.

Because printed polymeric layer 106 is disposed at least between first polymeric layer 102 and second polymeric layer 104, it is necessary for first polymeric layer 102, second polymeric layer, printed polymeric layer, or a combination thereof are visually transparent. Suitable levels of transmissivity can range from about 50% to about 100% about 80% to about 90%, less than, equal to, or greater than about 50%, 55, 60, 65, 70, 75, 80, 85, 90, 95, or about 100%. This allows a person to be able to see through at least some portion of multi-layer film to see visual image 108. While at least one of first polymeric layer 102 and second polymeric layer 104 must be visually transparent, another of first polymeric layer 102 and second polymeric layer 104, can be less transparent or even opaque as compared to the other.

The polymeric material of first polymeric layer 102, second polymeric layer 104, printed polymeric layer 106, or any other layer, can independently include a thermoplastic polymer a thermoset polymer, or a combination thereof. Specific examples of thermoplastic or thermoset polymers can include a polymer chosen from a polyethylene, a polyketone, a polyurethane, a polyamide, a polyester, copolymers thereof, and mixtures thereof. Where the polymer is a polyethylene, the polyethylene can include an ultra high molecular weight polyethylene (UHMWPE), a high-density polyethylene (HDPE), a cross-linked polyethylene (PEX or XLPE), a medium density polyethylene (MDPE), a linear low-density polyethylene (LLDPE), a metallocene catalyzed linear low-density polyethylene (mLLDPE), a low-density polyethylene (LDPE), a very low-density polyethylene (VLDPE), an ultra low-density polyethylene (ULDPE), a copolymer thereof, or a combination thereof. Where the polymer includes a polyester, the polyester includes polyethylene terephthalate, polyglycolide, polylactic acid, polycaprolactone, polyhydroxylalkanoate, polyhydroxbutyrate, polyethylene adipate, polybutylene succinate, polybutylene terephthalate, polytrimethylene terephthalate, polyethylene napthalate, copolymers thereof, or a combination thereof. In some examples, the polyethylene terephthalate is a glycol-modified polyethylene terephthalate.

Any of the first polymeric layer 102, second polymeric layer 104, or printed polymeric layer 106 can include an additive or mixture of additives to impart certain properties to the layers. For example, any of layer 102, 104, and 106 can include an additive or mixture of additives to inhibit the transmission of oxygen, inhibit the transmission of electromagnetic radiation, absorb electromagnetic radiation, an antioxidant, a stabilizer, an antifogging compound, or a combination thereof. In some examples, the polymeric layers 102, 104, or 106 can be entirely formed from a material that imparts any of these properties. For example, according to some examples, any of first polymeric layer 102, second polymeric layer 104, or both can be formed from ethylene vinyl alcohol in order to substantially block the transmission of oxygen through the layer to visual image 108.

As described further herein, multi-layer film 100 can be attached to a substrate to form an assembly. Attachment can be facilitated by including a bonding layer on first polymeric layer 102 or second polymeric layer 104. The bonding layer can be distributed over about 50% to about 100% of the total surface area of first polymeric layer 102 or second polymeric layer 104, about 90%, or less than, equal to, or greater than about 50%, 55, 60, 65, 70, 76, 80, 85, 90, 95, or about 100%. The bonding layer can include maleic anhydride, polypropylene, a pressure sensitive adhesive, a thermosensitive adhesive, a thermoset adhesive, a polyurethane, an ethylene methyl acrylate, an ethylene vinyl acetate, an epoxy, a polyurethane, a polyolefin, or a combination thereof. In some examples, it can be desirable for the material of the bonding layer to be the same as or substantially the same as the material of substrate (or at least the material present on the surface of the substrate that contacts the bonding layer). Bonding between the bonding layer and the substrate can be accomplished by heating the bonding layer. In these situations, a melting point or glass transition temperature of printed polymeric layer 106 is higher than a melting point or glass transition temperature of the bonding layer.

In examples where first polymeric layer 102 or second polymeric layer 104 are external layers, either or both layer can be configured to be substantially scratch resistant. In still further examples, first polymeric layer 102, second polymeric layer 104, or both can include an embossed surface. In further examples, multi-layer film 100 can include a release liner attached to the first polymeric layer or the second polymeric layer. Although a variety of materials are described it is possible for at least two of first polymeric layer 102, second polymeric layer 104, and printed polymeric layer 106 to include different materials or different mixtures of materials.

FIG. 2 is a sectional diagram of multi-layer film 200. Multi-layer film 200 includes first polymeric layer 102, second polymeric layer 104, third polymeric layer 112, and fourth polymeric layer 114. Because printed polymeric layer 106 is disposed at least between third polymeric layer 112 and fourth polymeric layer 114, it is necessary for third polymeric layer 112, fourth polymeric layer 114, or a combination thereof are visually transparent. This allows a person to be able to see through at least some portion of multi-layer film 200 to see visual image 108. While at least one of third polymeric layer 112 and fourth polymeric layer 114 must be visually transparent, another of third polymeric layer 112 and fourth polymeric layer 114, can be less transparent or even opaque as compared to the other.

The polymeric material of third polymeric layer 112 or fourth polymeric layer 114, or any other layer, can independently include a thermoplastic polymer a thermoset polymer, or a combination thereof. Specific examples of thermoplastic or thermoset polymers can include a polymer chosen from a polyethylene, a polyketone, a polyurethane, a polyamide, a polyester, copolymers thereof, and mixtures thereof. Where the polymer is a polyethylene, the polyethylene can include an ultra high molecular weight polyethylene (UHMWPE), a high-density polyethylene (HDPE), a cross-linked polyethylene (PEX or XLPE), a medium density polyethylene (MDPE), a linear low-density polyethylene (LLDPE), a metallocene catalyzed linear low-density polyethylene (mLLDPE), a low-density polyethylene (LDPE), a very low-density polyethylene (VLDPE), an ultra low-density polyethylene (ULDPE), a copolymer thereof, or a combination thereof. Where the polymer includes a polyester, the polyester includes polyethylene terephthalate, polyglycolide, polylactic acid, polycaprolactone, polyhydroxylalkanoate, polyhydroxbutyrate, polyethylene adipate, polybutylene succinate, polybutylene terephthalate, poly trimethylene terephthalate, polyethylene napthalate, copolymers thereof, or a combination thereof. In some examples the polyethylene terephthalate is a glycol-modified polyethylene terephthalate.

Any of third polymeric layer 112 or fourth polymeric layer 114 can include an additive or mixture of additives to impart certain properties to the layers. For example, any of layer 112 or 114 can include an additive or mixture of additives to inhibit the transmission of oxygen, inhibit the transmission of electromagnetic radiation, absorb electromagnetic radiation, an antioxidant, a stabilizer, an antifogging compound, or a combination thereof. In some examples, the polymeric layers 112 or 114 can be entirely formed from a material that imparts any of these properties. For example, according to some examples, any of third polymeric layer 112, fourth polymeric layer 114, or both can be formed from ethylene vinyl alcohol in order to substantially block the transmission of oxygen through the layer to visual image 108.

As described further herein, multi-layer film 100 can be attached to a substrate to form an assembly. Attachment can be facilitated by including a bonding layer on third polymeric layer 112 or fourth polymeric layer 114. The bonding layer can be distributed over about 50% to about 100% of the total surface area of third polymeric layer 112 or fourth polymeric layer 114, about 90%, or less than, equal to, or greater than about 50%, 55, 60, 65, 70, 76, 80, 85, 90, 95, or about 100%. The bonding layer can include maleic anhydride, polypropylene, a pressure sensitive adhesive, a thermosensitive adhesive, a thermoset adhesive, a polyurethane, an ethylene methyl acrylate, an ethylene vinyl acetate, an epoxy, a polyurethane, a polyolefin, or a combination thereof. In some examples, it can be desirable for the material of the bonding layer to be the same as or substantially the same as the material of substrate (or at least the material present on the surface of the substrate that contacts the bonding layer). Bonding between the bonding layer and the substrate can be accomplished by heating the bonding layer. In these situations, a melting point or glass transition temperature of printed polymeric layer 106 is higher than a melting point or glass transition temperature of the bonding layer.

In examples where third polymeric layer 112 or fourth polymeric layer 114 are external layers, either or both layer can be configured to be substantially scratch resistant. In still further examples, third polymeric layer 112, fourth polymeric layer 114, or both can include an embossed surface. In further examples, multi-layer film 200 can include a release liner attached to the first polymeric layer or the second polymeric layer. Although a variety of materials are described it is possible for any of first polymeric layer 102, second polymeric layer 104, third polymeric layer 112, fourth polymeric layer 114, and printed polymeric layer 106 to include different materials or different mixtures of materials.

In some examples, either multi-layer film 100 or multi-layer film 200 can include one or more tie layers to help join adjacent layers. For example, a tie layer can be disposed between fourth polymeric layer 114 and second polymeric layer 104; between second polymeric layer 104 and printed polymeric layer 106; between third polymeric layer 112 and first polymeric layer 102; between first polymeric layer 102 and printed polymeric layer 106; or a combination thereof. A tie layer can be helpful to join to layers that are formed from noncompatible materials. An example of a suitable tie layer material can include maleic anhydride. As shown in FIG. 2, any of first polymeric layer 102 or second polymeric layer 104 can constitute a tie layer. Although FIGS. 1 and 2 only show three and five total layers respectively, it is within the scope of this disclosure for other multi-layer films to have any further plural numbers of layers.

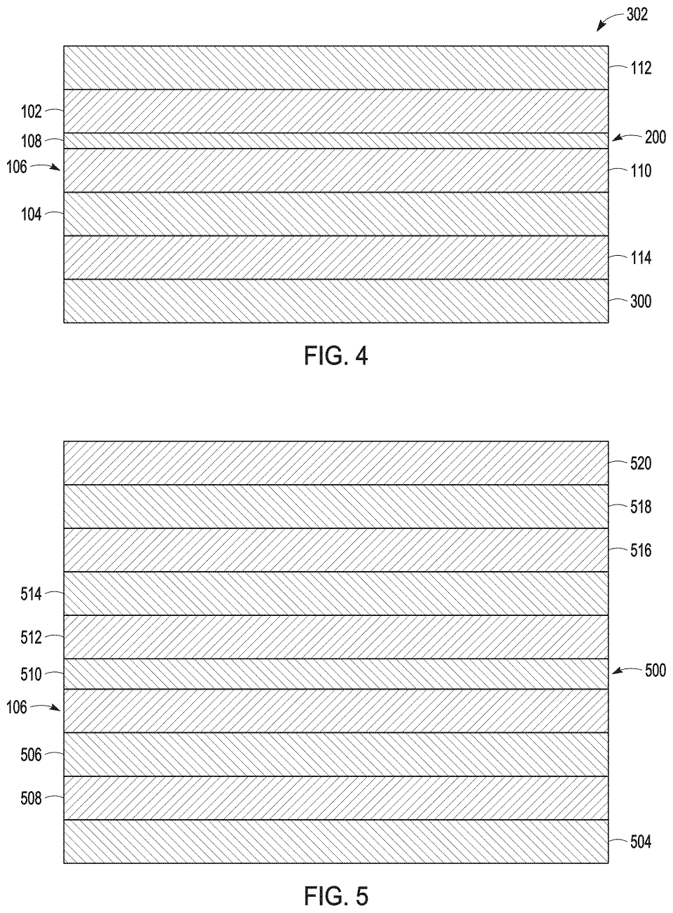

FIGS. 3 and 4 are sectional diagrams showing multi-layer films 100 and 200 attached to substrate 300, respectively to form assembly 302. Substrate 300 can include many suitable materials. For example, substrate 300 can include a wood, a metal, a plastic, a ceramic, or a mixture thereof. Where substrate 300 includes wood, the wood can include a particle board, an oriented strand board, a plywood, a paper, or a mixture thereof. Where substrate 300 includes a plastic, the plastic can include a polyolefin, a polyurethane, or a mixture thereof. In FIGS. 3 and 4, a direct bond is shown between multi-layer film 100 or 200 and substrate 300. This can be accomplished by having either second polymeric layer 104 or fourth polymeric layer 114 include the same material as at least the outer portion of substrate 300. Alternatively, the connection between multi-layer film 100 or 200 and substrate 300 can be facilitated with a bonding layer disposed therebetween.

Assembly 302 can be a at least a portion of many different products. For example, assembly 302 can be at least a portion of an article of furniture, a floor, a wall, a billboard, a fixture, or a combination thereof. In some specific examples, assembly 302 is a portion of a vehicle. For example, assembly 302 can be a wall (either external or internal) or floor of a recreational vehicle. The walls and floors of recreational vehicles typically require through-holes, bores, or cutouts to accommodate pipes, wires, outlets, switches or the like. Visual image 108 can direct a constructor where to form a void in assembly 302. Similarly, in a delivery truck shelving needs be applied to the interior walls of the delivery van. Visual image 108 can direct a constructor where to form a void in assembly 302 to insert brackets or other shelving components.

As shown in FIGS. 3 and 4, second polymeric layer 104 or fourth polymeric layer 114 are located between the printed polymeric layer 106 and substrate 300. This can allow for some variation in the properties or additives found in second polymeric layer 104 or fourth polymeric layer 114 as compared to first polymeric layer 102 and third polymeric layer 112. For example, assuming that light cannot transmit to printed polymeric layer 106 through substrate 300, it may not be necessary to design assembly 302 such that second polymeric layer 104 or fourth polymeric layer 114 to include additives to inhibit the transmission of electromagnetic radiation or absorb electromagnetic radiation because the risk of electromagnetic radiation being transmitted through substrate 300 and to printed polymeric layer 106, where visual image 108 may be damaged, is mitigated. Similarly, it may not be necessary for second polymeric layer 104 or fourth polymeric layer 114 to include an antioxidant or an additive to inhibit the transmission of oxygen. This is because second polymeric layer 104 or fourth polymeric layer 114 would be considered to be “internal layers” by virtue of their location between printed polymeric layer 106 and substrate 300 and would not be exposed to oxygen at the same level that “external layers” such as first polymeric layer 102 or third external layer 112 are. Moreover, any of second polymeric layer 104 or fourth polymeric layer 114 can be opaque or designed to be a specific color or mixture of colors of interest. The colors can help to create a contrast with visual image 108. Although a multi-layer film is only shown as present on one side of the substrate in further embodiments, it may be possible to include a second multi-layer film on the other side of the substrate. Assembly 302 can be framed on the sides so that the edges of printed polymeric layer 106 are not exposed.

Multi-layer film 100 or 200 can be formed according to may suitable methods. For example, visual image 108 can be applied to one side of polymeric material 110. If the side of polymeric material 110 is adjacent to first polymeric layer 102, visual image can be printed in a natural orientation. However, if the side of polymeric material 110 is adjacent to second polymeric layer 104, then visual image is printed in an inverse orientation. Printing can be accomplished using an ink jet printer.

Printed polymeric layer 106 is then brought into contact with at least first polymeric layer 102, second polymeric layer 104 or any tie layers. Polymeric layers 102 and 104 can be brought into further contact with tie layers or further polymeric layers such as third polymeric layer 112, fourth polymeric layer 114 as well as any further tie layers or polymeric layers.

After the polymeric layers and tie layers are assembled, the two resulting external surfaces can be contacted with a bonding layer and release liner respectively. The resulting multi-layer film precursor is then pressed to laminate the precursor and form multi-layer film 100 or 200. Multi-layer film 100 or 200 is then rolled. Multi-layer film 100 or 200 can then be unrolled and applied to substrate 300. If multi-layer film 100 or 200 includes a bonding layer, then bonding layer is brought into contact with substrate 300. However, if the external layer of multi-layer film 100 or 200 includes the same material as substrate, then the external layer without a bonding layer is brought into contact with substrate 300. Following contact multi-layer film 100 or 200 along with substrate 300 are heated to create a bond therebetween.

### EXAMPLES

Various embodiments of the present invention can be better understood by reference to the following Examples which are offered by way of illustration. The present invention is not limited to the Examples given herein.

### Working Example 1

Example 1 shows an example of a multi-layer film 500 as shown in sectional view in FIG. 5. Multi-layer film 5 includes external layers 510-520 and internal layers 504-508. Relative to printed polymeric layer 106, internal layers are intended to be located between printed polymeric layer 106 and a substrate whereas the external layers are intended to be located between the atmosphere and printed polymeric layer 106. Layer 520 is a release liner, layer 518 is a glycol-modified polyethylene terephthalate that includes additives for scratch resistance and to block ultra violet radiation. Layer 516 is a tie layer that includes ethylene methyl acrylate. Layer 514 includes ethylene vinyl alcohol to block transmission of oxygen but could also include nylon. Layer 512 is a tie layer that includes ethylene methyl acrylate. Layer 510 is a glycol-modified polyethylene terephthalate that is free of additives. Layer 510 is able to bond to printed polymeric layer 106 directly by virtue of each layer including polyethylene terephthalate. Layer 506 is a tie layer that includes ethylene methyl acrylate. Layer 508 includes ethylene vinyl alcohol to block transmission of oxygen. Layer 504 includes polypropylene to bind to a substrate that also includes polypropylene.

### Working Example 2

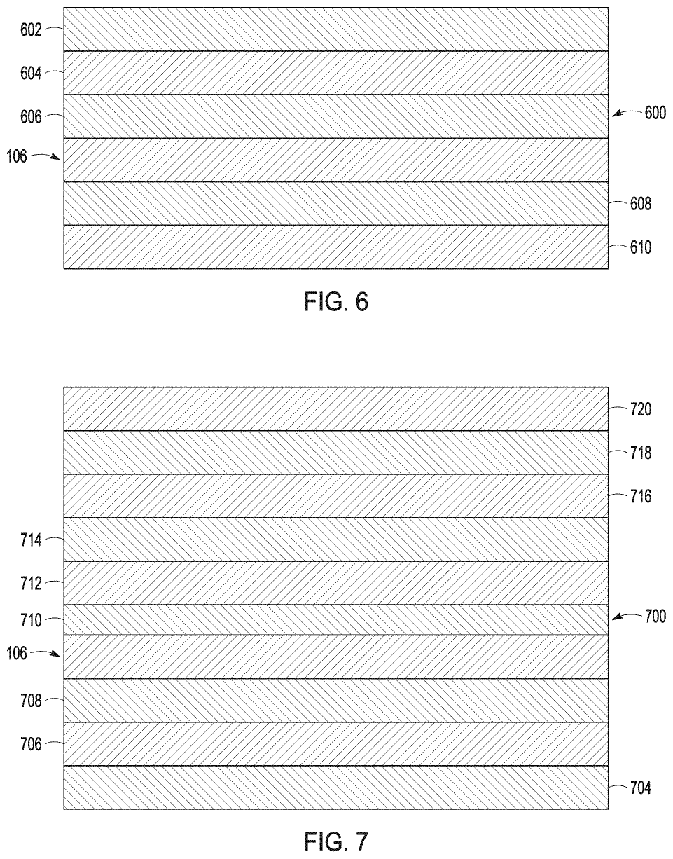

Example 2 shows an example of a multi-layer film 600 as shown in a sectional view in FIG. 6. As shown in FIG. 6, multi-layer film 600 includes external layers 602-606 and internal layers 608-610. Layer 602 is a release liner. Layer 604 is a glycol-modified polyethylene terephthalate that includes additives for scratch resistance and to block ultraviolet radiation. Layer 606 includes is a glycol-modified polyethylene terephthalate that does not include additives for scratch resistance and to block ultraviolet radiation. Layer 106 is a printed polymer layer that also includes a glycol-modified polyethylene terephthalate. Layer 608 is a tie layer that includes ethylene methyl acrylate. Layer 610 includes polypropylene to bind to a substrate that also includes polypropylene.

### Working Example 3

Example 3 shows an example of a multi-layer film 700 as shown in a sectional view in FIG. 7. Multi-layer film 700 includes external layers 710-720 and internal layers 704-708. Layer 720 is a release liner, layer 718 is a clear nylon that includes additives for scratch resistance and to block ultraviolet radiation. Layer 716 is a tie layer that includes ethylene methyl acrylate. Layer 716 includes ethylene vinyl alcohol to block transmission of oxygen but could also include nylon. Layer 714 is a tie layer that includes ethylene methyl acrylate. Layer 712 is a glycol-modified polyethylene terephthalate that is free of additives. Layer 712 is able to bond to printed layer 106 directly by virtue of each layer including polyethylene terephthalate. Layer 708 is a tie layer that includes ethylene methyl acrylate. Layer 706 includes polyurethane. Layer 704 includes a thermoadhesive to bind to a substrate.

### Working Example 4

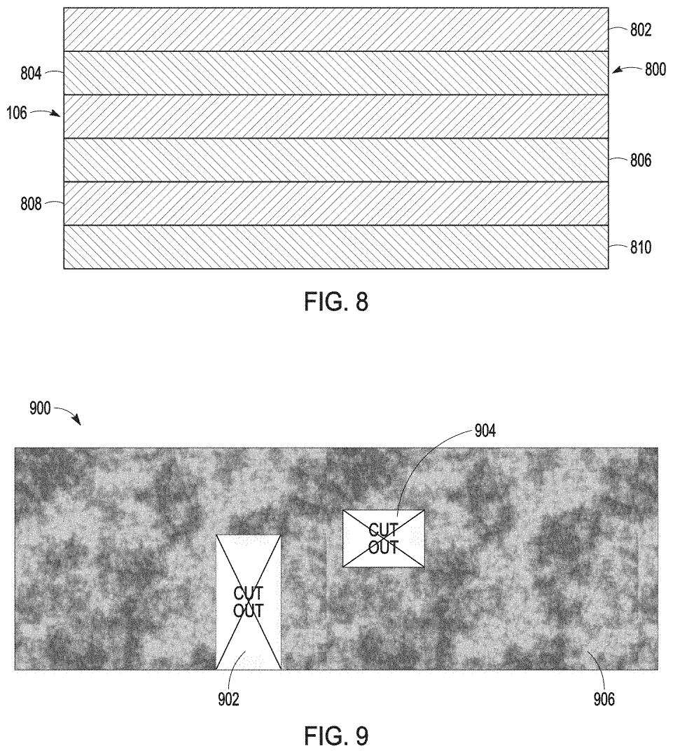

Example 4 shows an example of a multi-layer film 800 as shown in a sectional view in FIG. 8. Multi-layer film 800 includes external layers 802-804 and internal layers 806-810. Layer 802 is a release liner. Layer 804 is a glycol-modified polyethylene terephthalate that includes additives for scratch resistance and to block ultraviolet radiation. Layer 106 is a printed polymer layer that also includes a glycol-modified polyethylene terephthalate. Layer 806 is a tie layer that includes ethylene methyl acrylate. Layer 808 is nylon. Layer 810 is an adhesive that can include ethylene methyl acrylate.

### Working Example 5

Example 5 shows an example of a multi-layer film 900. Multi-layer film 900 includes first visual image 902, second visual image 904, and third visual image 906. Visual images 902, 904, and 906 are all present on printed polymeric 908, which can have the same properties as printed polymeric layer 106 as described herein. Visual images 902, 904, and 906 are visible through external layers as described herein such as first polymeric layer 120 and third polymeric layer 112, which are visually transparent. Multi-layer film 900 is part of a floor assembly in a recreational vehicle, although it could easily be applied in other assemblies. Visual image 906 is an aesthetic pattern that can provide the floor with an image that looks like natural wood or any other pattern. Visual images 902 and 904 are designated as cut outs and indicate where material is to be removed. Material can be removed for example to install a fixture. By virtue of visual images 902 and 904 indicating that those portions should be removed, an installer does not have to manually measure out sections of multi-layer film 900 to remove.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### EXEMPLARY EXAMPLES

The following exemplary examples are provided, the numbering of which is not to be construed as designating levels of importance:

Example 1 provides a multi-layer film comprising:

a first polymeric layer;

a second polymeric layer; and

a printed polymeric layer comprising a visual image and disposed between the first polymeric layer and the second polymeric layer.

Example 2 provides the multi-layer film of Example 1, wherein the first polymeric layer, the second polymeric layer or both comprises an additive or mixture of additives to inhibit the transmission of oxygen, inhibit the transmission of electromagnetic radiation, absorb electromagnetic radiation, an antioxidant, a stabilizer, an antifogging compound, or a combination thereof.

Example 3 provides the multi-layer film of Example 2, wherein first polymeric layer, second polymeric layer, or both comprise ethylene vinyl alcohol.

Example 4 provides the multi-layer film of any of Examples 1-3, wherein the first polymeric layer, second polymeric layer, printed polymeric layer, or a combination thereof are visually transparent.

Example 5 provides the multi-layer film of any one of Examples 1-4, wherein the first polymeric layer or the second polymeric layer are visually opaque.

Example 6 provides the multi-layer film of any one of Examples 1-5, wherein the first polymeric layer, second polymeric layer, printed polymeric layer, or a combination thereof independently comprise a thermoplastic polymer a thermoset polymer, or a combination thereof.

Example 7 provides the multi-layer film of any one of Examples 1-6, wherein the first polymeric layer, second polymeric layer, printed polymeric layer, or a combination thereof independently comprise a polymer chosen from a polyethylene, a polyketone, a polyurethane, a polyamide, a polyester, copolymers thereof, and mixtures thereof.

Example 8 provides the multi-layer film of Example 7, wherein the polyethylene of the first polymeric layer, second polymeric layer, or both independently comprises an ultra high molecular weight polyethylene (UHMWPE), a high-density polyethylene (HDPE), a cross-linked polyethylene (PEX or XLPE), a medium density polyethylene (MDPE), a linear low-density polyethylene (LLDPE), a metallocene catalyzed linear low-density polyethylene (mLLDPE), a low-density polyethylene (LDPE), a very low-density polyethylene (VLDPE), an ultra low-density polyethylene (ULDPE), a copolymer thereof, or a combination thereof.

Example 9 provides the multi-layer film of any one of Examples 1-8, wherein the polyester comprises polyethylene terephthalate, polyglycolide, polylactic acid, polycaprolactone, polyhydroxylalkanoate, polyhydroxbutyrate, polyethylene adipate, polybutylene succinate, polybutylene terephthalate, polytrimethylene terephthalate, polyethylene napthalate, copolymers thereof, or a combination thereof.

Example 10 provides the multi-layer film of Example 9, wherein the polyethylene terephthalate comprises a glycol-modified polyethylene terephthalate.

Example 11 provides the multi-layer film of any one of Examples 1-10, wherein at least two of the first polymeric layer, second polymeric layer, and printed polymeric layers comprise different materials or different mixtures of materials.

Example 12 provides the multi-layer film of any one of Examples 1-11, further comprising a tie layer disposed between any of the first polymeric layer, second polymeric layer, and printed polymeric layer.

Example 13 provides the multi-layer film of any one of Examples 1-12, wherein the first polymeric layer the second polymeric layer, or both are directly joined to the printed layer.

Example 14 provides the multi-layer film of any one of Examples 1-13, further comprising a bonding layer disposed on the first polymeric layer, second polymeric layer, or both.

Example 15 provides the multi-layer film of Example 14, wherein the bonding layer comprises polypropylene, a pressure sensitive adhesive, a thermosensitive adhesive, a thermoset adhesive, a polyurethane, an ethylene methyl acrylate, an ethylene vinyl acetate, an epoxy, a polyurethane, a polyolefin, or a combination thereof.

Example 16 provides the multi-layer film of any one of Examples 1-15, wherein the first polymeric layer, second polymeric layer, or both are scratch resistant.

Example 17 provides the multi-layer film of any one of Examples 1-16, wherein the first polymeric layer, second polymeric layer, or both comprises an embossed surface.

Example 18 provides the multi-layer film of any one of Examples 1-17, wherein the visual image is disposed adjacent to the first polymeric layer.

Example 19 provides the multi-layer film of any one of Examples 1-18, wherein the visual image is disposed adjacent to the second polymeric layer.

Example 20 provides the multi-layer film of any one of Examples 1-19, further comprising a release liner attached to the first polymeric layer or the second polymeric layer.

Example 21 provides the multi-layer film of any one of Examples 1-20, further comprising a third polymeric layer adjacent to the first polymeric layer and a fourth polymeric layer adjacent to the second polymeric layer.

Example 22 provides the multi-layer film of Example 21, wherein the third polymeric layer, the fourth polymeric layer or both comprises an additive or mixture of additives to inhibit the transmission of oxygen, inhibit the transmission of electromagnetic radiation, absorb electromagnetic radiation, an antioxidant, a stabilizer, an antifogging compound, or a combination thereof.

Example 23 provides the multi-layer film of Example 22, wherein the third polymeric layer fourth polymeric layer, or both comprise ethylene vinyl alcohol.

Example 24 provides the multi-layer film of any of Examples 21-23, wherein the third polymeric layer, fourth polymeric layer, or a combination thereof are visually transparent.

Example 25 provides the multi-layer film of any one of Examples 21-24, wherein the third polymeric layer, fourth polymeric layer, or a combination thereof independently comprise a thermoplastic polymer, a thermoset polymer, or a combination thereof.

Example 26 provides the multi-layer film of any one of Examples 24-25, wherein the third polymeric layer, fourth polymeric layer, or a combination thereof independently comprise a polymer chosen from a polyethylene, a polyketone, a polyurethane, a polyamide, a polyester, copolymers thereof, and mixtures thereof.

Example 27 provides the multi-layer film of Example 26, wherein the polyethylene of the third polymeric layer, fourth polymeric layer, or both independently comprises an ultra high molecular weight polyethylene (UHMWPE), a high-density polyethylene (HDPE), a cross-linked polyethylene (PEX or XLPE), a medium density polyethylene (MDPE), a linear low-density polyethylene (LLDPE), a metallocene catalyzed linear low-density polyethylene (mLLDPE), a low-density polyethylene (LDPE), a very low-density polyethylene (VLDPE), an ultra low-density polyethylene (ULDPE), a copolymer thereof, or a combination thereof.

Example 28 provides the multi-layer film of any one of Examples 26 or 27, wherein the polyester comprises polyethylene terephthalate, polyglycolide, polylactic acid, polycaprolactone, polyhydroxylalkanoate, polyhydroxbutyrate, polyethylene adipate, polybutylene succinate, polybutylene terephthalate, polytrimethylene terephthalate, polyethylene napthalate, copolymers thereof, or a combination thereof.

Example 29 provides the multi-layer film of Example 28, wherein the polyethylene terephthalate comprises a glycol-modified polyethylene terephthalate.

Example 30 provides the multi-layer film of any one of Examples 21-29, further comprising a tie layer disposed between the first polymeric layer and the third polymeric layer, between the second polymeric layer and the fourth polymeric layer, or a combination thereof.

Example 31 provides the multi-layer film of any one of Examples 21-30, further comprising a release liner attached to the third polymeric layer or fourth polymeric layer.

Example 32 provides the multi-layer film of any one of Examples 14-31, wherein the bonding layer is disposed on the third polymeric layer, fourth polymeric layer, or both.

Example 33 provides the multi-layer film of any one of Examples 1-32, wherein the polymeric printed layer comprises a metalized surface.

Example 34 provides the multi-layer film of any one of Examples 1-33, wherein the polymeric printed layer comprises an opaque ink, a transparent ink, a conductive ink, or a mixture thereof.

Example 35 provides the multi-layer film of any one of Examples 1-34, wherein the visual image comprises words, a picture, a pattern, numbers, or a combination thereof.

Example 36 provides the multi-layer film of Example 35, wherein the visual image comprises a pattern of shapes indicating a location to create a void.

Example 37 provides the multi-layer film of any one of Examples 35 or 36, wherein the visual image comprises a set of instructions.

Example 38 provides the multi-layer film of any one of Examples 35-37, wherein the visual image comprises a picture.

Example 39 provides the multi-layer film of any one of Examples 14-38, wherein a melting point or glass transition temperature of the printed polymeric layer is higher than a melting point or glass transition temperature of the bonding layer.

Example 40 provides the multi-layer film of any one of Examples 21-29, wherein the third polymeric layer, fourth polymeric layer, or both are scratch resistant.

Example 41 provides the multi-layer film of any one of Examples 21-40, wherein the third polymeric layer, fourth polymeric layer, or both comprises an embossed surface.

Example 42 provides the multi-layer film of any one of Examples 1-41, wherein the printed image is an inverted image.

Example 43 provides the multi-layer film of any one of Examples 1-42, wherein a thickness of the multi-layer film is in a range of from about 25 μm to about 6 mm.

Example 44 provides the multi-layer film of any one of Examples 1-43, wherein a thickness of the multi-layer film is in a range of from about 100 μm to about 1 mm.

Example 45 provides a multi-layer film comprising:

a first polymeric layer;

a second polymeric layer; and

a printed polymeric layer comprising a visual image and disposed between the first polymeric layer and the second polymeric layer;

wherein,
the first polymeric layer, the second polymeric layer or both comprises an additive or mixture of additives to inhibit the transmission of oxygen, inhibit the transmission of electromagnetic radiation, absorb electromagnetic radiation, an antioxidant, a stabilizer, an antifogging compound, or a combination thereof, and
the visual image comprises words, a picture, a pattern, numbers, or a combination thereof.

Example 46 provides an assembly comprising:

the multi-layer film of any one of Examples 1-45; and

a substrate adhered to the multi-layer film, wherein the visual image on the printed polymer layer is visible on a surface of the substrate through the first or second polymeric layer.

Example 47 provides the assembly of Example 46, wherein the substrate comprises a wood, a metal, a plastic, a ceramic, or a mixture thereof.

Example 48 provides the assembly of any one of Examples 45 or 46, wherein the wood comprises a particle board, an oriented strand board, a plywood, a paper, or a mixture thereof.

Example 49 provides the assembly of any one of Examples 45-48, wherein the plastic comprises a polyolefin, a polyurethane, or a mixture thereof.

Example 50 provides the assembly of any one of Examples 45-49, wherein the assembly is at least a portion of an article of furniture, a floor, a wall, a fixture, or a combination thereof.

Example 51 provides the assembly of any one of Examples 45-50, wherein the assembly is a portion of a vehicle.

Example 52 provides the assembly of any one of Examples 45-51, wherein the second polymeric layer or the fourth polymeric layer are located between the printed layer and the substrate.

Example 53 provides the assembly of Example 52, wherein the second polymeric layer, fourth polymeric layer or both are visually opaque, free of additives to inhibit the transmission of oxygen, inhibit the transmission of electromagnetic radiation, absorb electromagnetic radiation, an antioxidant, or a combination thereof.

Example 54 provides a method of making the multi-layer film of any one of Examples 1-53, the method comprising:

arranging the first polymeric layer, second polymeric layer, and printed polymeric layer to form a multi-layer film precursor; and

laminating the multi-layer film precursor to form the multi-layer film.

Example 55 provides the method of Example 54, wherein laminating comprises heating the multi-layer film precursor to a temperature below the melting point or glass transition temperature of the printed polymeric layer.

Example 56 provides the method of any one of Examples 54 or 55, further comprising arranging the third polymeric layer and the fourth polymeric layer with respect to the first polymeric layer and the second polymeric layer.

Example 57 provides the method of any one of Examples 54-56, wherein the printed polymeric layer is laminated to the second polymeric layer followed by the first polymeric layer being laminated to the printed polymeric layer.

Example 58 provides the method of Example 57, wherein the bonding layer is attached to the second polymeric layer before lamination of the first polymeric layer.

Example 59 provides the method of Example 57, wherein the fourth polymeric layer is laminated to the second polymeric layer before lamination of the first polymeric layer.

Example 60 provides the method of Example 59, wherein the bonding layer is attached to the fourth polymeric layer.

Example 61 provides a method of using the multi-layer film of any one of Examples 46-60, the method comprising bonding the multi-layer film to the substrate.

Example 62 provides the method of Example 61, further comprising forming a void in the multi-layer assembly and substrate.

Example 63 provides the method of Example 62, wherein the void extends through the multi-layer film and the substrate.

Example 64 provides the method of any one of Examples 62 or 63, wherein the void is formed at a location commensurate with a location where the visual image, or a portion thereof, is located in the printed polymeric layer.

Example 65 provides the method of any one of Examples 61-64, comprising applying a back light to the assembly to reveal a portion of the visual image.

What is claimed is:

1. A multi-layer film comprising:
a first polymeric layer;
a second polymeric layer; and
a printed polymeric layer comprising a visual image and disposed between the first polymeric layer and the second polymeric layer.

2. The multi-layer film of claim 1, wherein the first polymeric layer, second polymeric layer, printed polymeric layer, or a combination thereof are visually transparent.

3. The multi-layer film of claim 1, wherein the first polymeric layer or the second polymeric layer are visually opaque.

4. The multi-layer film of claim 1, wherein the first polymeric layer, second polymeric layer, printed polymeric layer, or a combination thereof independently comprise a thermoplastic polymer a thermoset polymer, or a combination thereof.

5. The multi-layer film of claim 1, wherein the first polymeric layer, second polymeric layer, printed polymeric layer, or a combination thereof independently comprise a polymer chosen from a polyethylene, a polyketone, a polyurethane, a polyamide, a polyester, copolymers thereof, and mixtures thereof.

6. The multi-layer film of claim 1, wherein the polyester comprises polyethylene terephthalate, polyglycolide, polylactic acid, polycaprolactone, polyhydroxylalkanoate, polyhydroxbutyrate, polyethylene adipate, polybutylene succinate, polybutylene terephthalate, polytrimethylene terephthalate, polyethylene napthalate, copolymers thereof, or a combination thereof.

7. The multi-layer film of claim 1, wherein the visual image is disposed adjacent to the first polymeric layer.

8. The multi-layer film of claim 1, wherein the visual image is disposed adjacent to the second polymeric layer.

9. The multi-layer film of claim 1, further comprising a third polymeric layer adjacent to the first polymeric layer and a fourth polymeric layer adjacent to the second polymeric layer.

10. The multi-layer film of claim 9, wherein the third polymeric layer, the fourth polymeric layer or both comprises an additive or mixture of additives to inhibit the transmission of oxygen, inhibit the transmission of electromagnetic radiation, absorb electromagnetic radiation, an antioxidant, a stabilizer, an antifogging compound, or a combination thereof.

11. The multi-layer film of claim 1, wherein the polymeric printed layer comprises a metalized surface.

12. The multi-layer film of claim 1, wherein the polymeric printed layer comprises an opaque ink, a transparent ink, a conductive ink, or a mixture thereof.

13. The multi-layer film of claim 1, wherein the visual image comprises words, a picture, a pattern, numbers, or a combination thereof.

14. The multi-layer film of claim 13, wherein the visual image comprises a pattern of shapes indicating a location to create a void.

15. The multi-layer film of claim 13, wherein the visual image comprises a set of instructions.

16. The multi-layer film of claim 13, wherein the visual image comprises a picture.

17. The multi-layer film of claim 14, wherein a melting point or glass transition temperature of the printed polymeric layer is higher than a melting point or glass transition temperature of the bonding layer.

18. A multi-layer film comprising:
a first polymeric layer;
a second polymeric layer; and
a printed polymeric layer comprising a visual image and disposed between the first polymeric layer and the second polymeric layer;
wherein,
the first polymeric layer, the second polymeric layer or both comprises an additive or mixture of additives to inhibit the transmission of oxygen, inhibit the transmission of electromagnetic radiation, absorb electromagnetic radiation, an antioxidant, a stabilizer, an antifogging compound, or a combination thereof, and
the visual image comprises words, a picture, a pattern, numbers, or a combination thereof.

19. An assembly comprising:
the multi-layer film of claim 1; and
a substrate adhered to the multi-layer film, wherein the visual image on the printed polymer layer is visible on a surface of the substrate through the first or second polymeric layer.

20. A method of making the multi-layer film of claim 1, the method comprising:
arranging the first polymeric layer, second polymeric layer, and printed polymeric layer to form a multi-layer film precursor; and
laminating the multi-layer film precursor to form the multi-layer film.
